(19) United States
(12) Patent Application Publication
(10) Pub. No.: US 2015/0345210 A1
(43) Pub. Date: Dec. 3, 2015

(54) PANEL ASSEMBLY FOR DOOR MEMBER OF MACHINE

(71) Applicant: Caterpillar Inc., Peoria, IL (US)

(72) Inventors: Iyyappan Balasubramanian, Pondicherry (IN); Evan R. Sanders, Peoria, IL (US); Andrew G. Greuel, Morton, IL (US)

(73) Assignee: Caterpillar Inc., Peoria, IL (US)

(21) Appl. No.: 14/826,225

(22) Filed: Aug. 14, 2015

(51) Int. Cl. E06B 7/00; E06B 3/70; E06B 9/01; E06B 3/36

(52) U.S. Cl. CPC E06B 7/00; E06B 3/36; E06B 3/70; E06B 9/01; E06B 2003/7046; E06B 2003/7049; E06B 2003/7059

(57) ABSTRACT

A panel assembly associated with a door member of a machine is provided. The panel assembly includes a frame assembly having a first section and a second section. A frame element is provided between the first and second sections of the frame assembly. The first section of the frame assembly includes a window defined thereon. The second section includes a plurality of holes provided thereon. Further, a plurality of flange members extends from an outer periphery of the frame assembly. One edge of the frame assembly is hingedly coupled with respect to the door member. The panel assembly also includes a screen assembly associated with the first section of the frame assembly. The screen assembly includes a screen member having a plurality of holes provided thereon. The panel assembly further includes a plurality of isolation members. The panel assembly includes a gripping element coupled to the frame assembly.

### TECHNICAL FIELD

The present disclosure relates to a panel assembly, and more particularly to the panel assembly associated with a door member of a machine.

### BACKGROUND

Machines operating at worksites in forest areas or mine sites generally include protective structures associated therewith. These protective structures are generally associated with an operator cabin of the machine so that an operator seated within the operator cabin is provided with additional protection. The protective structures include screens provided in association with windows of the operator cabin. The protective structures provide protection to the operator, but yet permit the operator to see through the protective structures. The screens of the protective structures generally include wire meshes that are coupled by welding to a frame member of the respective window. The welding of such wire meshes add to an overall cost of the protective structures.

U.S. Pat. No. 7,252,325, hereinafter referred as the '325 patent, describes a side screen for a cab of a work vehicle, such as a skid steer loader. The side screen includes a panel having a number of strips defining openings there between. At least one reinforcing member, such as a rib, is formed in the screen, such as on a strip or on a panel section. An intermediate panel may also provide a section of relatively heightened rigidity. However, the '325 patent is specific to the side screen design and does not describe a solution that can be retrofitted onto existing machines.

### SUMMARY OF THE DISCLOSURE

In one aspect of the present disclosure, a panel assembly associated with a door member of a machine is provided. The panel assembly includes a frame assembly having a first section and a second section. A frame element is provided between the first and second sections of the frame assembly. The first section of the frame assembly includes a window defined thereon. The second section includes a plurality of holes provided thereon. The plurality of holes is arranged in a side by side relationship with each other. Further, a plurality of flange members extends from an outer periphery of the frame assembly. The frame assembly has a single piece stamped design, such that one edge of the frame assembly is hingedly coupled with respect to the door member. The panel assembly also includes a screen assembly removably coupled to the window of the first section of the frame assembly. The screen assembly includes a screen member having a plurality of holes provided thereon. The screen assembly has a single piece stamped design. The panel assembly further includes a plurality of isolation members coupled to an interior surface of the frame assembly. The plurality of isolation members is configured to isolate a transfer of mechanical vibrations through the panel assembly. The panel assembly includes a gripping element coupled to the frame assembly. The gripping element is adapted to assist the operator to swing the frame assembly about a hinged connection.

Other features and aspects of this disclosure will be apparent from the following description and the accompanying drawings.

### BRIEF DESCRIPTION OF THE DRAWINGS

FIG. 1 is a perspective view of an exemplary machine, according to one embodiment of the present disclosure;

FIG. 2 is a perspective view of a frame assembly associated with a panel assembly of FIG. 1, according to one embodiment of the present disclosure;

FIG. 3 is a perspective view of the panel assembly having a screen assembly, according to one embodiment of the present disclosure; and

FIG. 4 is a perspective view of a panel assembly associated with a side screen of the machine of FIG. 1, according to one embodiment of the present disclosure.

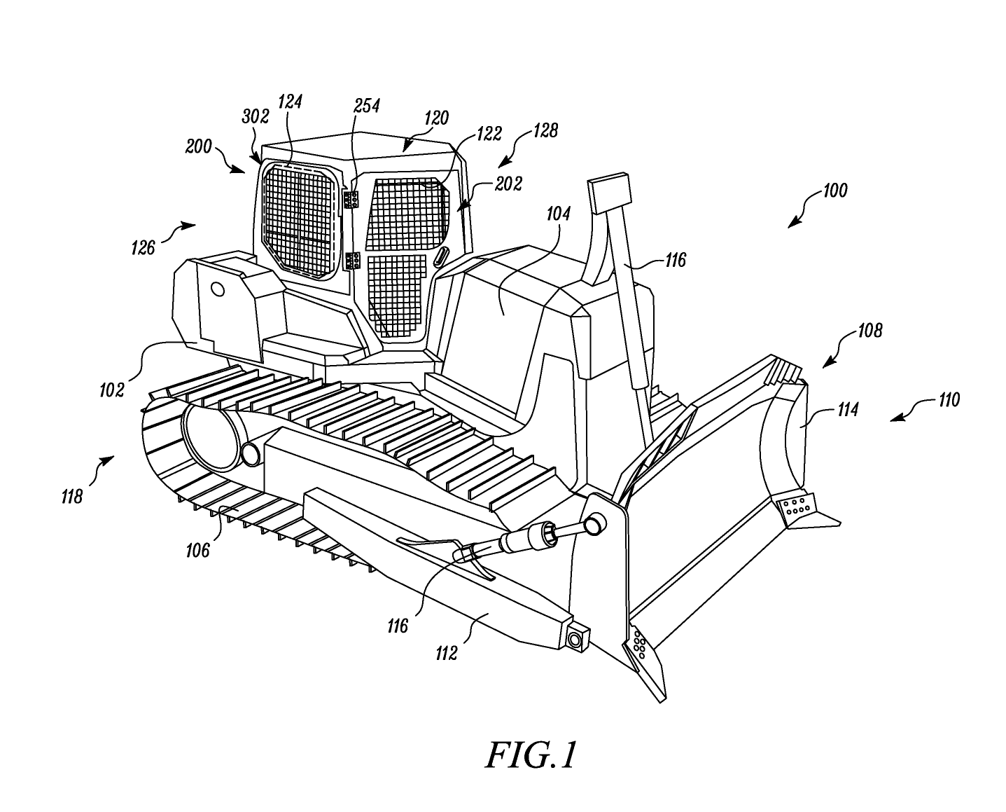

### DETAILED DESCRIPTION

Wherever possible, the same reference numbers will be used throughout the drawings to refer to the same or the like parts. Referring to FIG. 1, an exemplary machine 100 is depicted. More specifically, the machine 100 is a dozer.

The machine 100 includes a frame 102. A power source (not shown) is provided on the frame 102 of the machine 100. The power source is provided within an enclosure 104. The power source may be any power source known in the art, such as, an internal combustion engine, an electric motor, power storage device like batteries, and a hybrid engine. The power source provides power to the machine 100 for operational and mobility requirements. The machine 100 includes a set of ground engaging members 106, herein embodied as tracks. Alternatively, the ground engaging members 106 may include wheels. The ground engaging members 106 provide mobility to the machine 100. The machine 100 also includes a drivetrain (not shown) coupled to the power source and the ground engaging members 106. The drivetrain may include a transmission system having one or more gears, shafts, differentials, torque convertor, hydraulic pump or motor, and so on. The drivetrain transmits motive power from the power source to the ground engaging members 106.

The machine 100 includes an implement 114 coupled to the frame 102. An implement arrangement 108 is provided at a front section 110 of the machine 100. The implement arrangement 108 includes a linkage member 112. The linkage member 112 is coupled to the frame 102. The implement 114 is pivotally coupled to the linkage member 112. The implement 114 may be configured to collect, hold, and convey material and/or heavy objects on the ground. The implement arrangement 108 also includes hydraulic or pneumatic cylinders 116 for providing a required spatial movement to the linkage member 112 and the implement 114.

The implement 114 is embodied as a blade. Alternatively, the implement 114 may include any one of a bucket, an auger, a blade, a fork, a hammer, a ripper, or any other known work implement. The implement arrangement 108 is configured to perform tasks such as, earth moving, excavation, digging, demolition, and the like. Further, the implement arrangement 108 may be controlled electrically, mechanically, hydraulically, pneumatically, or by a combination thereof. Although a single implement arrangement 108 is shown in the accompanying figures, the machine 100 may include an additional implement arrangement provided at a rear section 118 of the machine 100.

The machine 100 also includes an operator cabin 120 provided on the frame 102 of the machine 100. The operator cabin 120 includes an operator interface (not shown). The operator interface includes one or more input devices like pedals, steering, joystick, knobs, levers, switches, display devices and so on.

The operator cabin 120 also includes a first door member 122 and a first side screen 124 provided adjacent to the first door member 122. The first door member 122 and the first side screen 124 are provided on a first side 126 of the machine 100. Further, the machine 100 also includes a second door member (not shown) and a second side screen (not shown) provided on a second side 128 of the machine 100. It should be noted that the design and construction of the second door member and the second side screen is similar to the design and construction of the first door member 122 and the first side screen 124.

The machine 100 includes a screen arrangement 200. The screen arrangement 200 includes a first panel assembly 202 and a second panel assembly (not shown). The first panel assembly 202 and the second panel assembly are coupled with the first door member 122 and the second door member of the operator cabin 120 respectively.

For illustrative purposes, the first panel assembly 202, hereinafter interchangeably referred to as panel assembly 202, associated with the first door member 122 will now be explained in detail. However, it should be noted that the description of the panel assembly 202 given below is equally applicable to the second panel assembly associated with the second door member, without limiting the scope of the present disclosure.

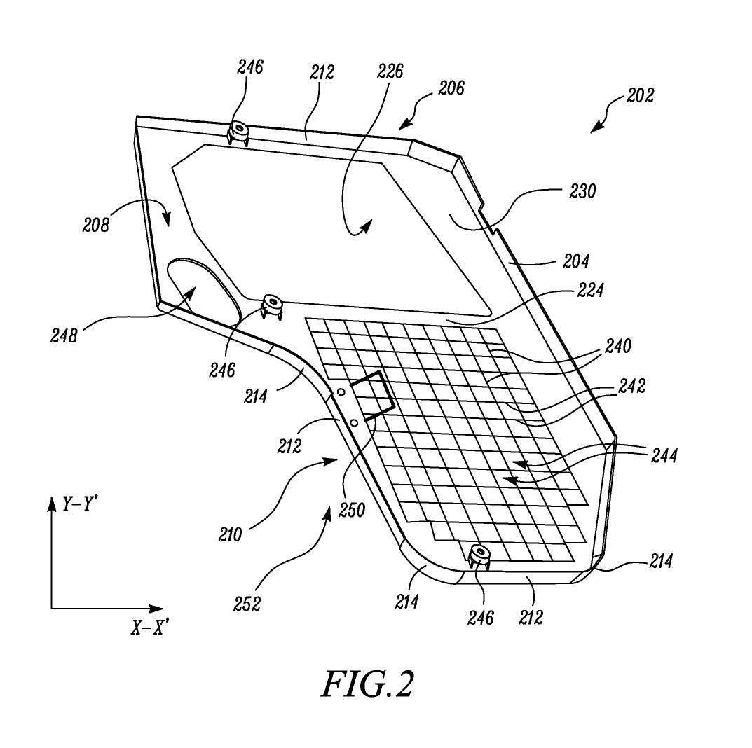

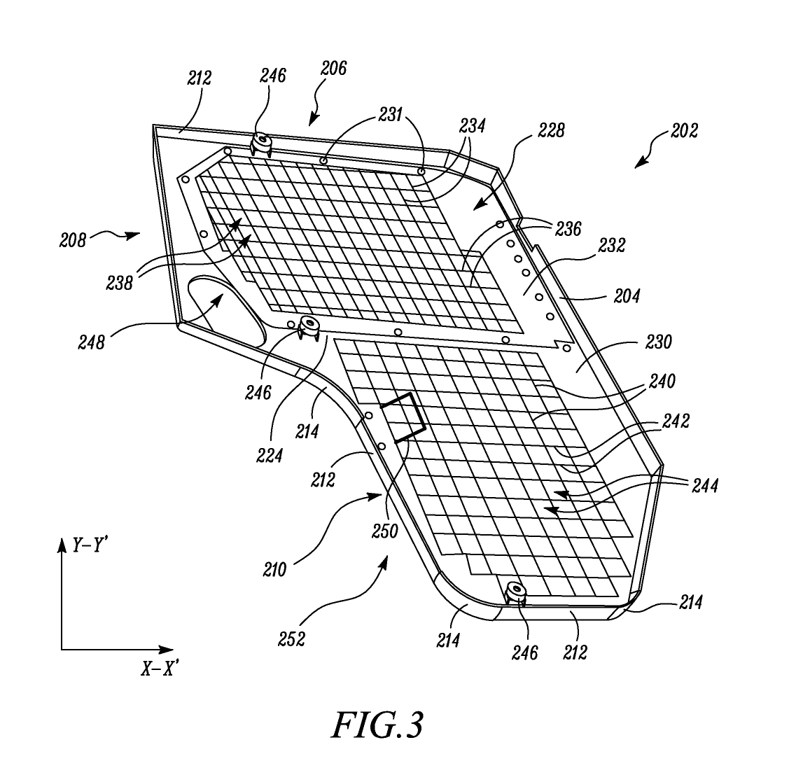

The panel assembly 202 is hingedly coupled to a portion of the machine 100. Referring to FIGS. 2 and 3, one edge 204 of the panel assembly 202 is hingedly coupled with respect to the first door member 122. The edge 204 of the panel assembly 202 includes a hinge connection 254 (see FIG. 1) to hingedly couple the panel assembly 202 with the portion of the machine 100.

An interior side 252 of the panel assembly 202 is illustrated in FIGS. 2 and 3. The interior side 252 of the panel assembly 202 faces the first door member 122 when the panel assembly 202 is coupled with the machine 100. The panel assembly 202 includes a frame assembly 206. The frame assembly 206 is embodied as a unitary component. More particularly, the frame assembly 206 has a single piece stamped design. The frame assembly 206 includes a first section 208 and a second section 210. The frame assembly 206 includes a number of flange members 212, 214. Each of the flange members 212, 214 extend from an outer periphery of the frame assembly 206. In one example, the frame assembly 206 includes three flange members 212 that form an integral part of the frame assembly 206. Whereas, the frame assembly includes three flange members 214 that are coupled to the adjacent flange members 212 by a suitable joining process, such as, welding.

As shown in the accompanying figures, the frame assembly 206 includes a frame element 224. The frame element 224 is provided between the first and second sections 208, 210 of the frame assembly 206. The frame element 224 separates the first section 208 from the second section 210. The first section 208 of the frame element 224 includes a window 226 provided therein.

Referring to FIG. 3, a screen assembly 228 is removably coupled to the window 226 of the first section 208 of the frame assembly 206. The screen assembly 228 is coupled to an inner surface 230 of the frame assembly 206. In one example, the screen assembly 228 is coupled to the first section 208 using mechanical fasteners 231. The mechanical fasteners 231 may include any one of a bolt, screw, pin, rivet, etc.

The screen assembly 228 includes a screen member 232. The screen member 232 is embodied as a unitary component and has a single stamped design. The screen member 232 includes a number of vertical ribs 234 provided in a spaced apart relationship along an axis X-X′. Further, the screen member 232 also includes a number of horizontal ribs 236. The horizontal ribs 236 are provided in a spaced apart relationship along an axis Y-Y′. The screen member 232 includes a number of holes 238 defined thereon with respect to the vertical and horizontal ribs 234, 236. The holes 238 are formed by punching the screen member 232.

Referring to FIGS. 2 and 3, the second section 210 of the frame assembly 206 includes a number of vertical ribs 240 provided in a spaced apart relationship along the axis X-X′. The vertical ribs 240 are provided at equal distances from each other. The frame assembly 206 also includes a number of horizontal ribs 242. The horizontal ribs 242 are spaced apart from each other along the axis Y-Y′. The horizontal ribs 242 are provided at equal distances from each other. The vertical and horizontal ribs 240, 242 are integrally formed with the frame assembly 206.

The second section 210 of the frame assembly 206 includes a number of holes 244 provided thereon. Each of the holes 244 are formed at an intersection of a pair of adjacently disposed horizontal ribs 242 and a pair of adjacently disposed vertical ribs 240. The holes 244 are arranged in a side by side relationship with each other, such that each adjacent hole 244 is separated by a single vertical rib 240 along the axis X-X′. Whereas the adjacent holes 244 provided along the axis Y-Y′ are separated by a single horizontal rib 242. The holes 244 are formed by punching the second section 210 of the frame assembly 206.

The panel assembly 202 includes a number of isolation members 246. The isolation members 246 are coupled to the inner surface 230 of the frame assembly 206. The isolation members 246 isolate a transfer of mechanical vibrations through the panel assembly 202. In one example, the isolation members 246 may reduce or eliminate a rattling noise that occurs due to a contact between the first door member 122 and the frame assembly 206 during an operation of the machine 100. The panel assembly 202 depicted FIGS. 2 and 3 include three isolation members 246. However, the isolation members 246 may vary based on system requirements. The isolation members 246 may be made of any non-metallic material that is capable of absorbing vibrations.

As shown in the FIGS. 2 and 3, the frame assembly 206 includes a slot 248. The slot 248 has an oblong profile. The slot 248 allows an operator of the machine 100 to access a latching arrangement (not shown) associated with the first door member 122 of the machine 100. A size of the slot 248 is decided such that the operator can conveniently access the latching arrangement of the first door member 122. The panel assembly 202 also includes a gripping element 250. The gripping element 250 is adapted to allow the operator to swing the panel assembly 202 about the hinged connection to enter into or to exit out of the operator cabin 120.

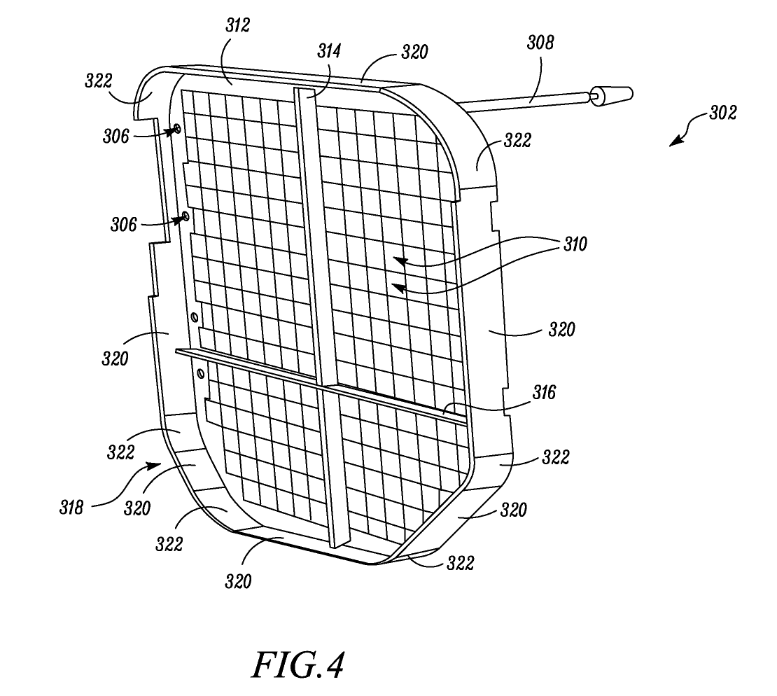

The screen arrangement 200 also includes a third panel assembly 302 and a fourth panel assembly (not shown) respectively associated with the first side screen 124 and the second side screen (not shown) of the operator cabin 120. FIG. 4 shows an interior side 318 of the third panel assembly 302 shown in FIG. 1. For illustrative purposes, the third panel assembly 302, associated with the first side screen 124 will now be explained in detail. However, it should be noted that the description of the third panel assembly 302 given below is equally applicable to the fourth panel assembly associated with the second side screen, without limiting the scope of the present disclosure.

Referring to FIG. 3, the third panel assembly 302 has an integral, one piece stamped design. The third panel assembly 302 is substantially square shaped with curved corners. The third panel assembly 302 includes a number of flange members 320, 322. The flange members 320 are integrally formed with the panel assembly 302. Whereas, the flange members 322 provided at corner portions of the panel assembly 302 are joined to adjacent flange members 320 by known processes, such as, welding.

The third panel assembly 302 is removably coupled with the first side screen 124. Further, the third panel assembly 302 includes mounting bores 306 for receiving mechanical fasteners 308 in order to fixedly couple the third panel assembly 302 with the first side screen 124. Further, the third panel assembly 302 includes a number of holes 310 provided thereon. In one example, the third panel assembly 302 may include isolation members (not shown) to isolate mechanical vibrations to and from the first side screen 124. The isolation members may be provided on an inner surface 312 of the third panel assembly 302.

The third panel assembly 302 includes a pair of support members 314, 316. The support members 314, 316 are provided on the inner surface 312 of the third panel assembly 302. The support members 314, 316 are provided perpendicular to each other. The support members 314, 316 maintain structural integrity and sturdiness of the third panel assembly 302.

Referring to FIGS. 2, 3, and 4, the holes 238, 244, 310 provided in the screen member 232, the second section 210, and the third panel assembly 302 respectively are provided using any punching device or any other metal removing device known in the art. Further, a number and size of the holes 238, 244, 310 may vary based on application requirements. In the embodiments shown in the accompanying figures, the holes 238, 244, 310 have a square shape. Alternatively, the holes 238, 244, 310 may be rhomboid, rectangular, circular, or trapezoidal in shape. Further, the panel assemblies 202, 302 may be made of any metal or non-metal known in the art that is sturdy in operation and does not deform easily.

The machine 100 shown in FIG. 1 may embody any machine including, but not limited to, a wheel loader, a backhoe loader, an excavator, a shovel, a mining truck, an articulated truck, a track type tractor, a forklift, a crane, and the like. The machine 100 may be any machine known in the art associated with industries including, but not limited to, agriculture, transportation, mining, construction, forestry, and material handling.

### INDUSTRIAL APPLICABILITY

Referring to FIGS. 2 and 3, the panel assembly 202 associated with the first door member 122 includes the removable screen assembly 228 coupled with the first section 208 of the panel assembly 202. The screen assembly 228 is removably coupled with the first section 208 using the mechanical fasteners 231. The panel assembly 202 also includes the second section 210. The second section 210 is integrally formed with the frame assembly 206. The screen assembly 228 and the second section 210 of the panel assembly 202 include the holes 238, 244. The holes 238, 244 are integrally provided in the screen assembly 228 and the second section 210 respectively. Hence, the cost associated with the welding of the wire meshes associated with earlier designs of panel assemblies is avoided. Further, the amount of inventory is also reduced as the use of additional elements, such as, the wire meshes is eliminated.

Further, the panel assembly 202 includes the flange members 212, 214. A majority of the flange members 212 are integrally formed with the panel assembly 202. Some portions of the flange members 214 are welded to the adjacent flange members 212. Therefore, overall the panel assembly 202 includes welded portions only at the flange members 214, thereby further reducing the welding cost associated with the panel assembly 202.

The screen arrangement 200 also includes the third panel assembly 302 shown in FIG. 4. The third panel assembly 302 also includes the holes 310 provided thereon. The panel assembly 202, 302 disclosed herein considerably reduces the cost associated with the production of such assemblies. In one example, the cost reduction may be approximately in a range between 70% and 85% compared to earlier designs. Further, the assembly time associated with the panel assembly 202, 302 is also reduced.

While aspects of the present disclosure have been particularly shown and described with reference to the embodiments above, it will be understood by one skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A panel assembly associated with a door member of a machine, the panel assembly comprising:
a frame assembly including a first section and a second section, wherein a frame element is provided between the first and second sections of the frame assembly, and wherein the first section of the frame assembly includes a window defined thereon, wherein the second section includes a plurality of holes provided thereon, the plurality of holes arranged in a side by side relationship with each other, and a plurality of flange members extending from an outer periphery of the frame assembly, wherein the frame assembly has a single piece stamped design, such that one edge of the frame assembly is hingedly coupled with respect to the door member;
a screen assembly removably coupled to the window of the first section of the frame assembly, the screen assembly including a screen member having a plurality of holes provided thereon, the screen assembly having a single piece stamped design;
a plurality of isolation members coupled to an interior surface of the frame assembly, the plurality of isolation members configured to isolate a transfer of mechanical vibrations through the panel assembly; and
a gripping element coupled to the frame assembly, the gripping element adapted to assist the operator to swing the frame assembly about a hinged connection.
